(19) United States
(12) Patent Application Publication
(10) Pub. No.: US 2001/0044277 A1
(43) Pub. Date: Nov. 22, 2001

(54) Method and device for digital wireless transmission of audio signals

(76) Inventors: Andreas Kremsl, Pitten (AT); Peter Schlager, Kirchberg a.d. Pielach (AT); Werner Lang, Wien (AT); Kurt Nell, Breitenfurt (AT); Ernst Stöttinger, Maria Enzersdorf (AT)

Correspondence Address: Friedrich Kueffner, Suite 1921, 342 Madison Avenue, New York, NY, 10173, US

(21) Appl. No.: 09/726,623

(22) Filed: Nov. 30, 2000

(30) Foreign Application Priority Data
Dec. 3, 1999 (AT) A 2040/99

(51) Int. Cl. H04B 7/00

(52) U.S. Cl. 455/66; 455/150.1

(57) ABSTRACT

In a method and device for digital wireless transmission of multi-channel audio signals from a player having a sender to at least one loudspeaker having a receiver, a signal picked up by the player is scanned based on clock pulses supplied by a quartz-controlled clock generator by a scanning rate converter provided in the sender. Clock recovery is employed in the receiver. The clock pulses of the clock generator are adjusted so as to coincide at least substantially precisely with a center frequency of the clock recovery of the receiver. In an alternative configuration, the scanning rate converter is replaced by a combination of a digital-to-analog converter and an analog-to-digital converter.

### BACKGROUND OF THE INVENTION

1. Field of the Invention

The invention relates to a method and a device for digital wireless transmission of multi-channel audio signals. Such methods and devices, for example, are used for wireless transmission of audio signals from players to headphones.

2. Description of the Related Art

The use of stereo signals for generating the impression of steric or spatial hearing has been known for a long time. This two-channel system has been expanded to more than two channels since its inception and has been used in many instances. The best known of these systems is the Dolby surround system having, depending on the embodiment, five and more channels. These channels are played back by means of a correspondingly high number of loudspeakers positioned around the listener, and this provides a real steric listening experience.

This steric hearing effect experienced by the human is produced, on the one hand, in that the sound of a point-shaped sound source reaches the two ears of the human with a slight temporal difference (except where the sound source is positioned in the symmetry plane between the ears) and, on the other hand, due to the fact that the hearing of the human, viewed as a sum total including reflection and absorptions at the shoulders etc., has an extremely complex directional characteristic which changes greatly depending on the incident angle of the incident signal until it finally reaches the eardrum. The unconscious knowledge of this characteristic, which differs from human to human, makes it possible for the human to locate a sound source within a space.

When a stereo signal or a multi-channel audio signal, in the form of two channels as a result of a corresponding combination thereof, is played for a listener via headphones, all of these differences are eliminated and the result is an “in head” listening experience or “in head” sound localization.

There are different methods to process the multi-channel signals so that they are supplied to the headphones in a pre-filtered state wherein the filter characteristics simulate the effect of the human ears and their direct surroundings. Moreover, with a corresponding travel time offset, the signal supplied to the right ear is also supplied to the left ear and vice versa.

In this way, a surprisingly complex and almost natural listening experience is provided with which, in particular, the “in head” listening experience, which is often experienced as being uncomfortable, can be reliably prevented.

The use of so-called cordless headphones has been known for a long time. In this case, the headphones are operated by means of batteries or accumulators and the signal transmission is realized by radio or infrared signals.

This transmission initially was realized with analog signals. However, with increasing use of digital carrier media (CDs, video discs, and the like) the audio signals have also been transmitted to a greater extent in digital format.

The digital transmission of audio signals, or actually of signals of any kind, entails the following difficulties. In order to be able to carry out reading of the transmitted signals correctly, it is necessary to know when an information package begins since, in contrast to analog transmission, the transmitted information is either completely correct or is not readable (makes no sense). Accordingly, controlled by clock generators of the player (CD players, video disc players, and the like) of the signals to be transmitted, the sending device introduces bit sequences at pre-defined locations in the transmission signals. These sequences are recognized by the receiver and its signal processing unit, for example, in the headphone, and make it possible that, beginning at these locations, the information can be read and further processed.

Substantially mirror-symmetrically to the clock generator of the player, the receiver circuitry also comprises a clock generator which, after completed synchronization, controls the further processing of the signals up to the point of detecting a successive control bit sequence in the incoming cycle and, when detecting the successive control bit sequence, then controls the synchronization and, if needed, repeats synchronization.

This measure is required because the processing of the received signals is carried out such that at points in time, which are predefined by the clock generator, the signals are read (scanned) and the transmitted information is determined in this way.

The information transmitted by the sender is that supplied by the electronic circuitry of the player; in these playing devices clock generators are provided which were able to fulfilled the requirements of the past wherein, of course, the congruence of the clock frequency between the devices was of no consequence because these devices work independent of one another and are not connected to one another. To this end, it is only necessary to provide clock stability which is sufficient to allow internal information-processing within the device and to prevent the generation of audible effects.

According to standard IEC 958 the tolerance range for the bit rate of audio signals is ±1,000 ppm. The jitter-free clock recovery for such great differences of the bit rate is possible only with a very wide broadband phase locked loop and very low noise level. If it is desired to suppress the jitter despite a high noise level, as is often the case for wireless transmission, the phase locked loop must be of a very narrow narrowband design, and this has the consequence that it locks only very slowly so that the audio transmission takes an unacceptable amount of time.

In the context of control-technological reasons, the noise level is smaller only by one magnitude in comparison to the lock range. From this the instability of the clock recovery explained in the following is directly apparent.

By employing the headphones with data transmission in a wireless fashion, there is the problem that one and the same headphone is used for different devices and that this headphone also must recognize, consider, and compensate the clock frequency which changes over time.

This is generally not a problem because by means of the phase locked loop, which is referred to as clock recovery, within the receiver the spacing of the pulse flanks of the clock signals (clock pulses) self-generated within the receiver are compared with the pulse flanks of the incoming data flow and, based on the determined temporal differences of the compared flanks, an error signal is derived with which the frequency and phase of the self-generated clock frequency is controlled and adjusted. Once congruence of the flanks has been reached, the clock recovery is perfect, and this is referred to as the locked state.

In regard to the locking process the following is submitted. Only when the clock recovery is in the locked state, the still required synchronization of the receiver will begin. The decoder searches systematically a periodically repeated identical bit or a bit group which is periodically inserted into the data flow by the encoder at the sender side for marking the word boundaries. Only when the receiver is synchronized, i.e., the synchronization bits (or words) expected by the receiver coincide with the received synchronization bits (or words), the audio signal is switched through to the headphone. This illustrates that once clock recovery has been lost, a considerably audible uncomfortable interruption occurs within the headphone even when the signal is immediately detected again.

Within the receiving range of such a device it may now be the case that with the unavoidable multi-path distribution of the radio waves the receiving level is weakened such that the clock recovery fails. This results in signal loss and the electronic processing unit within the receiver only delivers noise or an unpleasant disturbance. In order to prevent this noise which is unpleasant for the user, many such systems have a so-called squelch control or squelch circuit which prevents conduction of the signals to the speakers within the headphone when the clock recovery is not locked.

Since it can take quite some time until the clock recovery is again locked, the risk of signal loss is a considerable disadvantage of the known technology.

In order to prevent the signal loss as much as possible, i.e., in order to reduce the interference susceptibility, it would be necessary to reduce the noise bandwidth. This would be no problem technically, but now the aforementioned use of relatively cheap quartz elements with great tolerances of their clock precision in the players for digital storage devices has consequences because the frequency differences resulting therefrom make it necessary to design the lock range of the clock recovery so large that it can lock onto the fastest as well as the slowest bit rate of the different devices.

### SUMMARY OF THE INVENTION

It is an object of the present invention to solve this problem and to provide a method and a device of the aforementioned kind in which the interference susceptibility of the clock recovery is minimal and with which it is still possible to process the most different pre-defined clock frequencies available on the market.

In accordance with the present invention, this is achieved in that the signal picked up by the player and optionally converted into a stereo signal is scanned by means of a scanning rate converter provided in the sensor with clock pulses provided by a quartz-controlled clock generator and that the clock generator of the sender is at least substantially precisely adjusted to the center frequency of a preferably voltage-controlled quartz oscillator of the clock recovery provided in the receiver.

In a variant of the invention the scanning rate converter is replaced by a combination of a digital-to-analog converter connected at the analog side with an analog-to-digital converter.

With this measure the signal, which is reduced at the device side to two channels, is adjusted, independent of the quartz element of the player, by means of the scanning rate converter to a cycle rate which is practically constant from device to device as well as within the operating conditions and the service life of the device and which thus interacts as best as possible with the clock recovery control circuit provided at the receiver. As a result of the minimal pull-in range of the preferred voltage-controlled quartz oscillator, the noise bandwidth of the clock recovery is also correspondingly small. Accordingly, it is very insensitive with respect to noise and disturbances so that the loss of the lock, i.e., losing the signal, can be reliably prevented in practically all cases within the receiving range of the receiver.

Since the clock adjustment is carried out in the sender, no new components are required in the receiver which is beneficial with respect to the wearing comfort in the case of headphones as well as with regard to the energy consumption in the case of battery operation. Since this clock adjustment is carried out at a location of the data flow where it is present in the two-channel form, i.e., as a stereo signal, the expenditure for the required components and thus the investment and labor costs are minimal.

### BRIEF DESCRIPTION OF THE DRAWING

In the drawing:

FIG. 1 illustrates the configuration of a sender according to the prior art;

FIG. 2 illustrates a special prior art embodiment of the sender according to patent document WO 97/25834; and

FIG. 3 shows schematically the sender according to the present invention.

### DESCRIPTION OF THE PREFERRED EMBODIMENTS

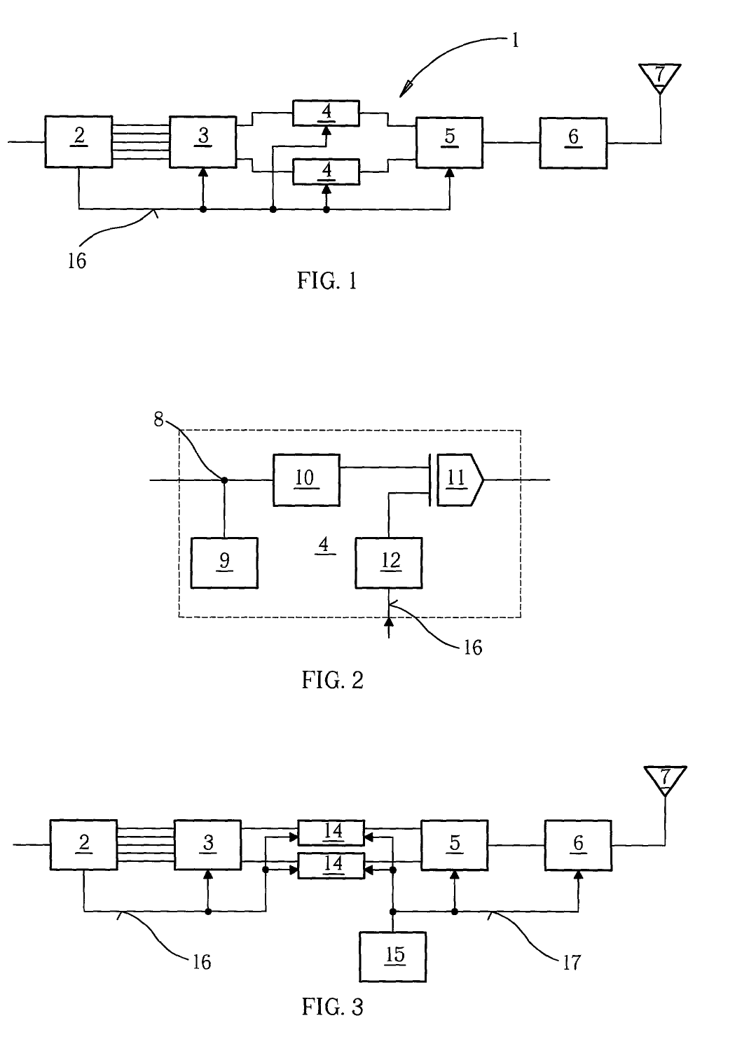

As can be seen in FIG. 1, the sender 1 cooperating with the players according to the prior art is comprised of a Dolby decoding device 2; a binaural synthesizing circuit 3, whose output is a stereo signal, which according to the prior art is changed in a modifying unit 4 in order to prevent loss of the signal of the clock recovery in the receiver as much as possible; an encoding device 5 arranged downstream which combines the two signal flows to a continuous signal flow; and a UHF component 6 in which the signal flow modulates the carrier signal generated in the UHF component and emitted via the antenna 7. All components which are used in this embodiment according to the prior art are clocked by the clock pulses 16 of the clock generator of the player. This results in the above-mentioned disadvantages, in particular, a considerable jitter, and causes the problems to be solved by the present invention.

A method employed according to the prior art for reducing the frequency of signal loss is illustrated in FIG. 2. FIG. 2 shows one of the two modifying devices 4. The incoming signal is overlaid by a noise signal of a noise generator 9 at the combination location 8 so that reliably a sufficient number of flanks is formed which can be recognized and used by the clock recovery in the receiver. Subsequently, the binary signal is converted in the filter 10 into a bipolar signal so that the switching threshold is set to zero volt and the noise becomes effective when over a longer period of time no pulse flank occurs. An additional measure is the subsequent “exclusive or” which combines the data flow with an alternating bit sequence; this is also done to provide a sufficient number of flanks. The digital signal modulated by noise via the sender is processed in the receiver—a digital wireless headphone—such that the overlaid noise is again removed and the alternating bit sequence is also again converted into the original sequence.

In regard to jitter the following is submitted. When ideal rectangular symbols (digital signal sequence) of 0 and 1 are sent through a filter, a “smudging” of the data pulses results which can be referred to as intersymbol interference (as a result of the non-linear processing). When such an original ideal data sequence is to be transmitted by wireless transmission, it is necessary to make the filter as narrow as possible in order to accommodate as many channels as possible within a limited frequency range. A pulse is smudged the more within a certain time period the narrower the filter. This means that, at the time of scanning, the scanned value at the receiver output is no longer the actually transmitted value of 0 or 1, but, as a function of the previous happenings, is 0.3 or 0.8, for example. When these distorted pulses are processed by a processing device such that, for example, values smaller than 0.5 are “zero” and values greater 0.5 are “one” and are converted into a rectangular meander function, it is directly apparent that the portions with the value 0 or the value 1 have different lengths, i.e., the flanks of these pulses fluctuate about the actual correct value; this is referred to as jitter. With this conversion of the smudged frequency band limited data a widening of the spectrum results. In order to eliminate the jitter, which is generated by the non-linear processing of the intersymbol interference, and to reduce it, if possible, to only one spectral line, i.e., the clock frequency, the spectrally widened signal is filtered out by means of a phase locked loop which corresponds to a cleanup loop. This method is referred to as clock recovery.

In absolute values it can be stated that the effective value of an jitter should not surpass 100 picoseconds because otherwise it is already audible as a disturbance. When viewed as a spectral function, jitter can be viewed as sideband noise of the clock signal, and its suppression can be carried out during clock recovery by means of a narrowband filter.

In order to avoid the above mentioned problems, the sender according to the invention is configured as illustrated schematically in FIG. 3 by means of a block diagram.

At the input side a Dolby decoding device 2 is provided and at the output a multi-channel signal is present which is converted by the binaural synthesizing circuit 3 into a stereo signal. This stereo signal is supplied according to the invention to a scanning rate converter 14 (for each channel) whose clock pulses 17 at the output side are generated by the clock generator 15 provided according to the invention. According to the invention, this clock generator 15 is precise and stable within a narrowly predefined frame so that the data flow supplied to the encoder 5 after its combination within the high frequency component 6 can modulate also the carrier signal to be modulated with high precision so that the recovery circuit at the receiver side can be designed with minimal sensitivity and thus high stability. Of course, the encoding device and the modulating device are also controlled and cycled by the clock generator 15 provided at the sender.

By employing the frequency-precise and phase-pure clock generator 15, the jitter is reduced to such an extent that the phase locked loop (PLL) can have such a high quality that it is able to bridge even several disturbed intervals (i.e., it thus scans and evaluates in a quasi blind way, within its on responsibility, the received signal) before it requires again a measurable flank for locking.

The same can be achieved by employing a digital-to-analog converter and an analog-to-digital converter whose analog sides are oriented toward one another. In this case, the input digital signal is converted to an analog signal in the digital-to-analog converter and is transformed with the precisely cycled analog-to-digital converter into a jitter-free digital data stream.

While specific embodiments of the invention have been shown and described in detail to illustrate the inventive principles, it will be understood that the invention may be embodied otherwise without departing from such principles.

What is claimed is:

1. A method for digital wireless transmission of multi-channel audio signals from a player comprising a sender to at least one loudspeaker comprising a receiver, the method comprising the steps of:
scanning, based on clock pulses supplied by a quartz-controlled clock generator by a scanning rate converter provided in the sender, a signal picked up by the player;
employing a clock recovery in the receiver;
adjusting the clock pulses of the clock generator so as to coincide at least substantially precisely with a center frequency of the clock recovery of the receiver.

2. The method according to claim 1, further comprising the step of converting the signal picked up by the player into a stereo signal before the step of scanning.

3. A method for digital wireless transmission of multi-channel audio signals from a player comprising a sender to at least one loudspeaker comprising a receiver, the method comprising the steps of:
scanning, based on clock pulses supplied by a quartz-controlled clock generator by a combination of a digital-to-analog converter and an analog-to-digital converter provided in the sender, a signal picked up by the player;
employing a clock recovery in the receiver;
adjusting the clock pulses of the clock generator so as to coincide at least substantially precisely with a center frequency of the clock recovery of the receiver.

4. The method according to claim 3, further comprising the step of converting the signal picked up by the player into a stereo signal before the step of scanning.

5. A device for digital wireless transmission of multi-channel audio signals from a player comprising a sender to at least one loudspeaker comprising a receiver according to the method of claim 1, the device comprising:
a scanning rate converter configured to be arranged in the sender of the player for each channel of the signal picked up by the player;
a quartz-controlled clock generator configured to supply clock pulses to scan the scanning rate converter, wherein the clock generator is configured such that the clock pulses of the clock generator coincide at least substantially precisely with a center frequency of a clock recovery of the receiver.

6. The method according to claim 5, wherein the signal picked up by the player is converted into a stereo signal.

7. A device for digital wireless transmission of multi-channel audio signals from a player comprising a sender to at least one loudspeaker comprising a receiver according to the method of claim 5, the device comprising:
a combination of a digital-to-analog converter and an analog-to-digital converter configured to be arranged in the sender of the player for each channel of the signal picked up by the player;
a quartz-controlled clock generator configured to supply clock pulses to scan the analog-to-digital converter, wherein the clock generator is configured such that the clock pulses of the clock generator coincide at least substantially precisely with a center frequency of a clock recovery of the receiver.

8. The method according to claim 7, wherein the signal picked up by the player is converted into a stereo signal.
